(19) United States
(12) Patent Application Publication
(10) Pub. No.: US 2026/0149266 A1
(43) Pub. Date: May 28, 2026

(54) METHOD AND APPARATUS FOR CONTROLLING ARC SUPPRESSION DEVICE

(71) Applicant: ABB Schweiz AG, Baden (CH)

(72) Inventors: Janne Leminen, Tampere (FI); Saku Siermala, Vaasa (FI); Janne Altonen, Tampere (FI)

(21) Appl. No.: 19/395,776

(22) Filed: Nov. 20, 2025

(30) Foreign Application Priority Data
Nov. 22, 2024 (EP) 24214682.7

(51) Int. Cl. H02H 9/02

(52) U.S. Cl. CPC H02H 9/02

(57) ABSTRACT

A method and apparatus for controlling an arc suppression device of a three-phase electric network, the arc suppression device having an adjustable admittance connected between a neutral point of the three-phase electric network and earth, the apparatus being configured to determine a resonant frequency of a zero-sequence system of the three-phase electric network, determine at least two frequencies for a current injection on the basis of the determined resonant frequency, perform a current injection into the neutral point of the three-phase electric network by using the determined at least two frequencies, determine a value of at least one parameter related to the three-phase electric network on the basis of the current injection, and use the determined value of the at least one parameter for adjusting the admittance of the arc suppression device.

### CROSS-REFERENCE TO RELATED APPLICATIONS

This application claims priority to European Patent Application No. 24214682.7, filed Nov. 22, 2024 and titled “METHOD AND APPARATUS FOR CONTROLLING ARC SUPPRESSION DEVICE”, the entire contents of which are hereby incorporated by reference.

### TECHNICAL FIELD

The present disclosure relates to a method and an apparatus for controlling an arc suppression device.

### BACKGROUND

An arc suppression device can be used for compensating a fault current caused by a single-phase-to-earth fault. An example of the arc suppression device is an Arc Suppression Coil, ASC, which is a passive inductive device that is connected between a neutral point of an electric system (for example, network) and earth to limit the capacitive earth-fault current flowing, when a single-phase-to-earth fault occurs in the system. The ASC was originally developed by Waldemar Petersen and is therefore sometimes referred to as the Petersen Coil. This kind of system earthing method may be called as the resonant earthing. The resonant earthing is a commonly used earthing practice in medium voltage networks, for example, and it has been used in several countries for many decades with good operational experiences. An example of the ASC is disclosed in U.S. Pat. No. 1,537,371. An electric network provided with one or more such arc suppression devices may be referred to as a compensated network.

The idea of the resonant earthing may be generally to match, either essentially completely or at least partially, an admittance of the arc suppression device(s) to the total phase-to-earth capacitance formed by the network conductors. In this case the magnitude of the earth-fault current at the fault location can be limited below the level of self-extinguishment, which can suppress transient earth faults without a feeder tripping. Also, the touch and hazard voltages can be limited with the decreased fault current value, which also can limit the danger to public and property, and improve safety to personnel.

In order to set the admittance value of the arc suppression device(s) to match the total phase-to-earth capacitance of the network conductors, at least one inductance, provided by e.g., for example, one or more adjustable coils, of the arc suppression device may be variable and a controller device (for example, a coil controller) can be used. The purpose of such a controller device is to adjust, in other words, tune, the arc suppression device admittance to match, either essentially completely or at least partially, the total phase-to-earth capacitance value of the network. And if the phase-to-earth capacitance value of the network changes, the controller device may again adjust (tune) the admittance of the arc suppression device(s) to match the changed phase-to-earth capacitance value of the network. Such tuning of the arc suppression device(s) may generally include injecting an alternating current signal into the neutral point of the network (zero-sequence current injection) which enables to determine one or more network parameters or a state of the network detuning based on which the arc suppression device(s) can be tuned or adjusted. An example of such solution is disclosed in DE 10307668 B3.

A possible problem related to such solutions utilizing the current injection for the tuning of the arc suppression device is that the level (amplitude) of sufficient injection current, and hence the power, required to enable the determination of the one or more network parameters or the state of the network detuning may be high.

### BRIEF DESCRIPTION

An object of the present disclosure is to provide a method and an apparatus for implementing the method so as to overcome the above problem or at least to alleviate the above problem. The objects of the present disclosure are achieved by the subject-matter of the independent claim. Further exemplary embodiments are evident from the dependent claims and the following description. The embodiments and features, if any, described in this specification that do not fall under the scope of the independent claim are to be interpreted as examples useful for understanding various embodiments of the present disclosure.

The present disclosure is based on the idea of determining a resonant frequency of a zero-sequence system of the three-phase electric network, determining at least two frequencies for a current injection on the basis of the determined resonant frequency and performing the current injection into the neutral point of the three-phase electric network by using the determined at least two frequencies.

According to an aspect of the present disclosure, a method for controlling an arc suppression device of a three-phase electric network is provided. The arc suppression device has an adjustable admittance connected between a neutral point of the three-phase electric network and earth. The method comprises determining a resonant frequency of a zero-sequence system of the three-phase electric network, determining at least two frequencies for a current injection on the basis of the determined resonant frequency, performing a current injection into the neutral point of the three-phase electric network by using the determined at least two frequencies, determining a value of at least one parameter related to the three-phase electric network on the basis of the current injection, and using the determined value of the at least one parameter for adjusting the admittance of the arc suppression device.

According to another aspect, an apparatus for controlling an arc suppression device of a three-phase electric network is provided. The arc suppression device has an adjustable admittance connected between a neutral point of the three-phase electric network and earth. The apparatus is configured to: determine a resonant frequency of a zero-sequence system of the three-phase electric network, determine at least two frequencies for a current injection on the basis of the determined resonant frequency, perform a current injection into the neutral point of the three-phase electric network using the determined at least two frequencies, determine a value of at least one parameter related to the three-phase electric network based on the current injection, and use the determined value of the at least one parameter for adjusting the admittance of the arc suppression device.

According to another aspect, a controller for an arc suppression device for a three-phase electric network is provided. The arc suppression device has an adjustable admittance configured to be connected between a neutral point of the three-phase electric network and earth. The controller comprises a processor and a memory storing instructions that, when executed by the processor, cause the controller to determine a resonant frequency of a zero-sequence system of the three-phase electric network, determine at least two frequencies for a current injection based on the determined resonant frequency, perform a current injection into the neutral point of the three-phase electric network using the determined at least two frequencies, determine a value of at least one parameter related to the three-phase electric network based on the current injection, and adjust the admittance of the arc suppression device using the determined value of the at least one parameter.

An advantage of the solution of the present disclosure is that the frequencies used in the current injection can be adjusted according to the prevailing network configuration and consequently the power required for the current injection can be reduced.

### BRIEF DESCRIPTION OF DRAWINGS

The subject matter of the present disclosure will be explained in more detail in the following text with reference to exemplary embodiments which are illustrated in the attached drawings.

FIG. 1 is an example of a three-phase electric network according to an embodiment of the present disclosure.

FIG. 2 is an example of a three-phase electric network according to an embodiment of the present disclosure.

FIG. 3 illustrates a diagram according to an embodiment of the present disclosure.

FIG. 4 illustrates a flow diagram according to an embodiment of the present disclosure.

FIG. 5 illustrates a diagram according to an embodiment of the present disclosure.

FIG. 6 illustrates a diagram according to an embodiment of the present disclosure.

FIG. 7 illustrates a block diagram according to an embodiment of the present disclosure.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

Different embodiments and examples may be described below using single units, models, equipment and memory, for example, without restricting the embodiments/examples to such a solution. Concepts called cloud computing and/or virtualization may be used. The virtualization may allow a single physical computing device to host one or more instances of virtual machines that appear and operate as independent computing devices, so that a single physical computing device can create, maintain, delete, or otherwise manage virtual machines in a dynamic manner. It is also possible that device operations will be distributed among a plurality of servers, nodes, devices or hosts. In cloud computing network devices, computing devices and/or storage devices may provide shared resources. Some other technology advancements, such as Software-Defined Networking (SDN), may cause one or more of the functionalities described below to be migrated to any corresponding abstraction or apparatus or device. Therefore, all words and expressions should be interpreted broadly, and they are intended to illustrate, not to restrict, the embodiment in question.

The application of the various embodiments described herein is not limited to any specific system, but it can be used in connection with various three-phase electric networks with a compensated neutral, also known as resonant-earthed networks, where compensation of fault current is achieved by installing one or more arc suppression devices, such as Arc Suppression Coils (ASC), also known as Petersen coils or compensation coils, into neutral point(s) (star point, zero point) of the system. The electric network, in which the various embodiments may be implemented, can be an electric power transmission and/or distribution network or a portion or a component of a larger network, for example, and may comprise several electric lines and/or sections. The electric network may have a radial configuration supplied from one point thereof or a loop configuration comprising one or more loops and supplied from two or more points, or a combination of such configurations. Moreover, the use of the various embodiments is not limited to systems employing 50 Hz or 60 Hz fundamental frequencies or to any specific voltage level. Also a phase rotation order, such as L1-L2-L3 or L1-L3-L2, of the system does not limit the use of the various embodiments.

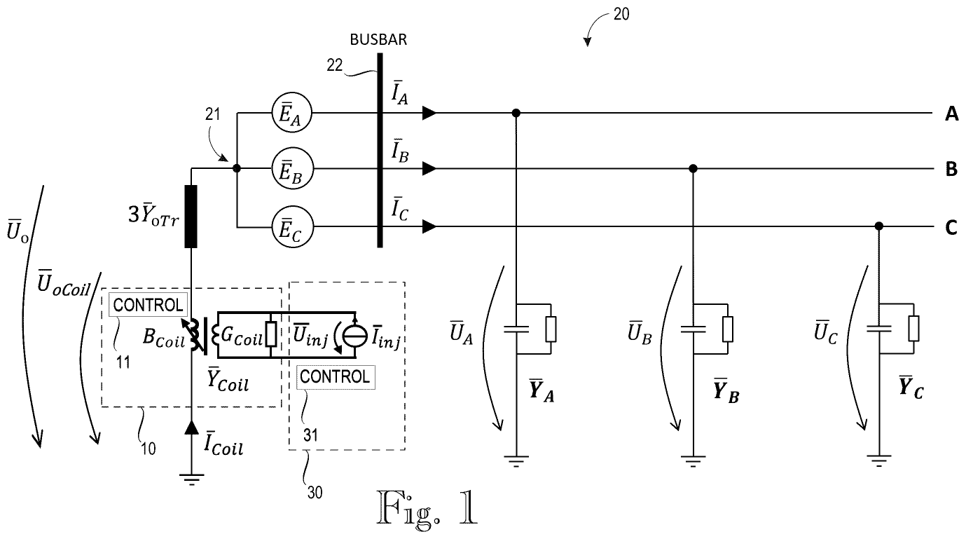

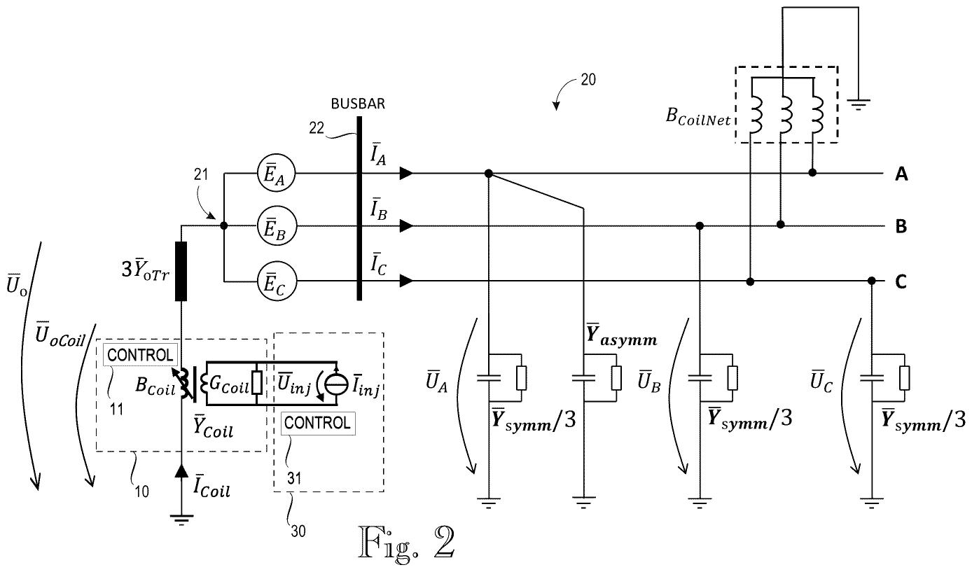

FIGS. 1 and 2 are simplified diagrams of an exemplary electric system (network) showing some equipment (for example, apparatuses, devices, nodes) and functional entities, whose implementation and/or number and/or configuration may differ from what is shown in the examples of FIGS. 1 and 2. Such a system may also comprise other equipment, functional entities and/or structures, some of which are used for big data, data management, and communication in the system or in any part of the system. Also, for example, any communications protocols used may vary and may depend on the system characteristics. FIGS. 1 and 2 are diagrams illustrating simplified equivalent circuits of a three-phase electric network in which the various embodiments can be applied. The exemplary three-phase network with phases A, B and C may be a medium voltage (for example, 20 kV) distribution network fed through a substation comprising a source Ē_{A}, Ē_{B}, Ē_{C}, such as a transformer or generally a feeding point of the electric network, and a feeding busbar 22 connected to one or more electric line outlets (feeders) 20. Respective phase currents of phases A, B and C are Ī_{A}, Ī_{B}, and Ī_{C}, with a positive current direction from the feeding point towards line as indicated by the arrows in the figure, and respective phase voltages are Ū_{A}, Ū_{B}, and Ū_{C}. FIGS. 1 and 2 further illustrate an arc suppression device (apparatus, equipment) 10, which is connected between a neutral point (star point, zero point) 21 of the three-phase electric network and earth. The arc suppression device 10 may be the only arc suppression device in the electric network or it may be a central arc suppression device, and the electric network may further comprise distributed compensation, in other words, one or more additional arc suppression devices distributed along the one or more electric line outlets (feeders) 20 and/or one or more additional arc suppression devices (not shown in the figures) located at the substation. The arc suppression device 10 can be connected to the neutral point 21 of the electric network via an earthing transformer or any other suitable arrangement. An admittance of the arc suppression device 10 is Y̅_{Coil} and the exemplary arc suppression device 10 as illustrated may comprise at least one adjustable coil. The arc suppression device 10 could comprise more than one adjustable and/or non-adjustable coil. Ī_{Coil} is the current flowing through the arc suppression device 10. The arc suppression device 10 may further include a controller for controlling, for example, tuning, the adjustable coil, and also for generally controlling any functionality of the arc suppression device 10. FIGS. 1 and 2 further illustrate a current injection device (apparatus, equipment) 30, which is connected in parallel to the arc suppression device 10. The current injection device 30 may be a separate device or entity, possibly in a separate housing, or the current injection device 30 may be an integrated part of the arc suppression device 10, such as a module thereof.

Current and voltage values used in the various embodiments described herein may be obtained by a suitable measuring arrangement, which may include current and/or voltage transducers (not shown in the figures) connected to the phases of the electric network or similar equipment. Voltage and current quantities may also be measured at different locations. In existing electric networks and systems, such values are typically readily available and thus the implementation of the various embodiments does not necessarily require any separate or additional measuring arrangements. It should be noted that, for example, admittance, conductance, and/or susceptance could be used in any calculations and definitions disclosed herein in an analogous manner instead of impedance, resistance, and/or reactance, and vice versa.

The figures also show a (first) control arrangement 11, such as a controller device or a control unit of the arc suppression device 10, located within the arc suppression device 10. Such a control arrangement 11 could also be located outside the arc suppression device 10 and could be configured to control more than one arc suppression devices 10. In the exemplary systems of FIGS. 1 and 2, at least part of the functionality of the various embodiments may be located in the control arrangement 11. The control arrangement 11 may be configured to receive necessary measurement data and/or perform at least some measurements by itself, and to control, in other words, tune, the adjustable coil of the arc suppression device 10. The figures further show a (second) control arrangement 31, such as a controller device or a control unit of the current injection device 30, located within the current injection device 30. Such a control arrangement 31 could also be located outside the current injection device 30. Such a control arrangement 31 could be a separate entity as illustrated in the examples or integrated with the control arrangement 11 of the arc suppression device 10. In the exemplary systems of FIGS. 1 and 2, at least part of the functionality of the various embodiments may be provided by means of the control arrangement 31 of the current injection device 30. It is thus possible that the functionalities of the first control arrangement 11 and the second control arrangement 31 are combined into one control arrangement which may thus control the operation of both the arc suppression devices 10 and the current injection device 30, for instance, and may implement at least part of the functionality of the various embodiments disclosed herein.

The following notation is used in FIG. 1 (overbar denotes a complex quantity):
Ē_{A} is the phase A to neutral voltage of the source,
Ē_{B} is the phase B to neutral voltage of the source,
Ē_{C} is the phase C to neutral voltage of the source,
Ū_{A} is the phase A to earth voltage at busbar,
Ū_{B} is the phase B to earth voltage at busbar,
Ū_{C} is the phase C to earth voltage at busbar,
Ūₒ is the neutral point voltage (the zero-sequence voltage) of the electric network, which can be measured, for example, at the busbar or at the source,
Īᵢₙⱼ is the injected current,
Ūᵢₙⱼ is the output voltage of the current injection device,
Ū_{Coil} is the voltage over the arc suppression device,
Ī_{A} is the phase A current at the source,
Ī_{B} is the phase B current at the source,
Ī_{C} is the phase C current at the source,
Ī_{Coil} is the current through the arc suppression device,
Y̅_{A} is the phase A to earth admittance of the electric network (excluding the arc suppression device 10),
Y̅_{B} is the phase B to earth admittance of the electric network (excluding the arc suppression device 10),
Y̅_{C} is the phase C to earth admittance of the electric network (excluding the arc suppression device 10),
Y̅_{oTr} is the zero-sequence admittance per phase of an earthing transformer or a main transformer, or another arrangement, which is used to form the neutral point of the electric network and through which the arc suppression device is connected to the electric network,
Y̅_{Coil}=G_{Coil}+j×B_{Coil} is the admittance of the arc suppression device,
j is the imaginary unit also known as a complex operator,
G_{Coil} is the conductance of the arc suppression device corresponding to the parallel resistor and the natural losses of the coil, and
B_{Coil} is the susceptance of the arc suppression device.

The notation used in FIG. 2 corresponds to that of FIG. 1 except that in FIG. 2 the inductive susceptance of the electric network due to possible distributed arc suppression device(s) B_{CoilNet} is shown separately and the individual phase admittances of the electric line outlets 20 are presented with symmetrical phase admittances, whose sum equals the symmetrical network admittance:

$${\overline{Y}}_{symm} = {G}_{symm} + j {B}_{symm}$$

Parameter G_{symm} is the real part of the symmetrical network admittance. The sign is positive and it represents the shunt losses of the electric network (excluding the losses of the arc suppression device). Parameter B_{symm} is the imaginary part of the symmetrical network admittance. The sign is positive (capacitive) and it represents the capacitive uncompensated earth-fault current of the electric network.

The natural asymmetry (unbalance) present in a real system is due to differences in individual phase admittances and it has thus in practice an arbitrary value. In FIG. 2 it is presented with an asymmetry admittance concentrated into phase A and presented with the asymmetry admittance:

$${\overline{Y}}_{asymm} = {G}_{asymm} + j {B}_{asymm}$$

The asymmetry admittance Y̅_{asymm}=G_{asymm}+j·B_{asymm} represents the asymmetry of the phase-to-earth admittances of the electric network reduced to a lumped admittance in phase A. Parameter G_{asymm} is the real part of asymmetry admittance. The sign may be positive or negative depending on the actual level of asymmetry. Parameter B_{asymm} is the imaginary part of asymmetry admittance. The sign may be positive or negative depending on the actual level of asymmetry, in other words, on the differences between the actual phase-to-earth admittances of the electric network.

The asymmetry admittance may also be calculated from phase-wise admittances as follows:

$${\overline{Y}}_{asymm} = {\overline{Y}}_{A} + {\overline{a}}^{2} \cdot {\overline{Y}}_{B} + \overline{a} \cdot {\overline{Y}}_{C}$$

The symmetry admittance may then be solved from the total admittance of the electric line outlets Y̅_{Net} as follows:

$${\overline{Y}}_{symm} = {\overline{Y}}_{Net} - {\overline{Y}}_{asymm} = {\overline{Y}}_{A} + {\overline{Y}}_{B} + {\overline{Y}}_{C} - {\overline{Y}}_{asymm}$$

In the example of FIG. 2 the following applies:

$${\overline{Y}}_{A} = \frac{{\overline{Y}}_{symm}}{3} + {\overline{Y}}_{asymm} - j \frac{{B}_{CoilNet}}{3}$$

$${\overline{Y}}_{B} = \frac{{\overline{Y}}_{symm}}{3} - j \frac{{B}_{CoilNet}}{3}$$

$${\overline{Y}}_{C} = \frac{{\overline{Y}}_{symm}}{3} - j \frac{{B}_{CoilNet}}{3}$$

The theoretical basis of the embodiments disclosed herein lies in the idea that the power requirement of the current injection may depend on a system (electric network) damping and detuning, and essentially the effect of system detuning can be disregarded by using frequencies close to the resonant frequency of the zero-sequence system. Typically, the possible resonant frequencies in, for example, compensated distribution networks may be in a range from about 10 to about 250 Hz, which is a wide range to cover using preselected frequencies. Therefore, according to an embodiment, the proposed solution uses dynamically selected frequencies that may be selected based on a determined resonant frequency of the three phase electric network so that network parameters can always be calculated using optimal frequencies. Thus, the power requirement of the current injection can be minimized in most or all the possible network tuning configurations even during severe detuning. For instance, this allows for the use of lower injection current amplitudes and/or operate in networks with higher detuning and damping levels without extensive power requirements.

The technical feasibility of using the resonant frequency can be understood based on following equations:

1. The total zero-sequence impedance and/or admittance of the three phase electric network (including the arc suppression device 10):

$$\begin{matrix}{\overline{Z}}_{0} ( {ω}_{i} ) & = \frac{- {\underline{U}}_{0} ( {ω}_{i} )}{{\overline{I}}_{inj}^{′} ( {ω}_{i} )} = \frac{1}{{G}_{Coil} - {jB}_{Coil} + {G}_{Net} + j ( {B}_{cNet} - {B}_{CoilNet} )} \\ & = \frac{1}{{G}_{Coil} + \frac{1}{j {ω}_{i} {L}_{Coil}} + {G}_{Net} + j ( {ω}_{i} {C}_{Net} - \frac{1}{{ω}_{i} {L}_{Net}} )} \\ & = \frac{1}{{G}_{0 Tot} + j ( {ω}_{i} {C}_{Tot} - \frac{1}{{ω}_{i} {L}_{Tot}} )} = \frac{1}{{I}_{d} - j ( \frac{{ω}_{s}}{{ω}_{i}} {I}_{Ltot} - \frac{{ω}_{i}}{{ω}_{s}} {I}_{Ctot} )} {U}_{PE} \\ & = \frac{1}{{I}_{d} - {jI}_{v}^{′}} {U}_{PE}\end{matrix}$$

$$\begin{matrix}{\overline{Y}}_{0} ( {ω}_{i} ) & = \frac{{\overline{I}}_{inj}^{′} ( {ω}_{i} )}{{\overline{U}}_{0} ( {ω}_{i} )} = {G}_{Coil} - {jB}_{Coil} + {G}_{Net} + j ( {B}_{cNet} - {B}_{CoilNet} ) \\ & = {G}_{Coil} + \frac{1}{j {ω}_{i} {L}_{Coil}} + {G}_{Net} + j ( {ω}_{i} {C}_{Net} - \frac{1}{{ω}_{i} {L}_{Net}} ) \\ & = {G}_{0 Tot} + j ( {ω}_{i} {C}_{Tot} - \frac{1}{{ω}_{i} {L}_{Tot}} ) = \frac{1}{{U}_{PE}} \cdot ( {I}_{d} - j ( \frac{{ω}_{s}}{{ω}_{i}} {I}_{Ltot} - \frac{{ω}_{i}}{{ω}_{s}} {I}_{Ctot} ) ) \\ & = \frac{{I}_{d} - {jI}_{v}^{′}}{{U}_{PE}}\end{matrix}$$

2. Zero-sequence voltage response due to current injection:

$$\begin{matrix}{\overline{U}}_{0} ( {ω}_{i} ) & = \frac{{\overline{I}}_{inj}^{′} ( {ω}_{i} )}{{\overline{Y}}_{0} ( {ω}_{i} )} = \frac{{\overline{I}}_{inj}^{′} ( {ω}_{i} )}{{G}_{Coil} - {jB}_{Coil} + {G}_{Net} + j ( {B}_{cNet} - {B}_{CoilNet} )} \\ & = \frac{{\overline{I}}_{inj}^{′} ( {ω}_{i} )}{{G}_{Coil} + \frac{1}{j {ω}_{i} {L}_{Coil}} + {G}_{Net} + j ( {ω}_{i} {C}_{Net} - \frac{1}{{ω}_{i} {L}_{Net}} )} \\ & = \frac{{\overline{I}}_{inj}^{′} ( {ω}_{i} )}{{G}_{0 Tot} + j ( {ω}_{i} {C}_{Tot} - \frac{1}{{ω}_{i} {L}_{Tot}} )} = \frac{{\overline{I}}_{inj}^{′} ( {ω}_{i} )}{{I}_{d} - j ( \frac{{ω}_{s}}{{ω}_{i}} {I}_{CoilTot} - \frac{{ω}_{i}}{{ω}_{s}} {I}_{cNet} )} {U}_{PE} \\ & = \frac{{\overline{I}}_{inj}^{′} ( {ω}_{i} )}{{I}_{d} - {jI}_{v}^{′}} {U}_{PE}\end{matrix}$$

At the resonant angular frequency (ωᵢ=ωᵣₑₛ) of the zero-sequence system of the electric network the above equations can be further simplified:

$${\overline{Z}}_{0} ( {ω}_{r e s} ) = \frac{{\overline{U}}_{0} ( {ω}_{r e s} )}{{\overline{I}}_{inj}^{′} ( {ω}_{r e s} )} = \frac{1}{{G}_{C o i l} + {G}_{Net}} = \frac{1}{{G}_{0 Tot}} = \frac{{U}_{P E}}{{I}_{d}}$$

$${\overline{Y}}_{0} ( {ω}_{r e s} ) = \frac{{\overline{I}}_{i n j}^{′} ( {ω}_{r e s} )}{{\overline{U}}_{0} ( {ω}_{r e s} )} = {G}_{C o i l} + {G}_{Net} = {G}_{0 Tot} = \frac{{I}_{d}}{{U}_{P E}}$$

$${\overline{U}}_{0} ( {ω}_{r e s} ) = \frac{{\overline{l}}_{inj}^{′} ( {ω}_{r e s} )}{{\overline{Y}}_{0} ( {ω}_{r e s} )} = \frac{{\overline{I}}_{i n j}^{′} ( {ω}_{r e s} )}{{G}_{C o i l} + {G}_{Net}} = \frac{{\overline{I}}_{i n j}^{′} ( {ω}_{r e s} )}{{G}_{0 Tot}} = \frac{{\overline{I}}_{i n j}^{′} ( {ω}_{r e s} )}{{l}_{d}} {U}_{P E}$$

where:
Iᵢₙⱼ is the injected current reduced to primary voltage level, for example, as:

$${\overline{I}}_{i n j}^{′} = \frac{{U}_{P A W}}{{U}_{P E}} \cdot {\overline{I}}_{inj}$$

where U_{PAW} is the rated voltage of the power auxiliary winding of the arc suppression device,
Ū₀ is the zero-sequence voltage of the electric network,
ωᵢ is the angular frequency of the current injection, which equals 2π·fᵢ,
fᵢ is the frequency of the current injection,
ωₛ is the synchronous angular frequency of the electric network, which equals 2π·fₛ,
fₛ is the synchronous frequency of the three-phase electric network, for example, 50 Hz. Alternatively, fₛ can also be a measured network frequency,
ωᵣₑₛ is the angular resonant frequency of the zero-sequence system of the electric network, which equals 2π·fᵣₑₛ (herein also referred as “network resonant angular frequency”),
fᵣₑₛ is the resonant frequency of the zero-sequence system of the electric network (herein also referred as “network resonant frequency”,
G_{Coil} is the conductance of the arc suppression device corresponding to the parallel resistor and the natural losses of the device,
B_{Coil} is the susceptance of the arc suppression device,
G_{Net} is the zero-sequence conductance of the electric network excluding the arc suppression device 10,
B_{cNet} is the zero-sequence capacitive susceptance of the electric network excluding the arc suppression device 10,
B_{CoilNet} is the zero-sequence inductive susceptance of the electric network due to distributed arc suppression device(s),
L_{Coil} is the inductance of the arc suppression device,
C_{Net} is the zero-sequence capacitance of the electric network excluding the arc suppression device 10,
L_{Net} is the zero-sequence inductance of the electric network due to distributed arc suppression device(s),
L_{Tot} is the total zero-sequence inductance of the electric network (including the arc suppression device 10). In this case,

$${L}_{Tot} = \frac{{L}_{C o i l} \cdot {L}_{N e t}}{{L}_{coil} + {L}_{Net}} ,$$

C_{Tot} is the total zero-sequence capacitance of the electric network (including the arc suppression device 10). In this case, C_{Tot}=C_{Net},
G_{0Tot} is the total zero-sequence conductance of the electric network (including the arc suppression device 10). In this case, G_{0Tot}=G_{Net}+G_{Coil},

$${I}_{v}^{′} = \frac{{ω}_{s}}{{ω}_{i}} {I}_{Ltot} - \frac{{ω}_{i}}{{ω}_{s}} {I}_{Ctot} ,$$

is the magnitude of the frequency-scaled electric network detuning,
I_{d} is the total electric network damping,
I_{Ctot} is the total capacitive earth fault current at fₛ of the electric network,
I_{Ltot} is the total inductive earth fault current produced by the arc suppression device 10 and any distributed arc suppression device(s) at fₛ of the electric network,
U_{PE} is the rated phase-to-earth voltage of the electric network, and

$${\overline{Y}}_{Net} = {G}_{Net} + j ( {B}_{cNet} - {B}_{CoilNet} ) = {\overline{Y}}_{A} + {\overline{Y}}_{B} + {\overline{Y}}_{C} = {\overline{Y}}_{symm} + {\overline{Y}}_{asymm} - {jB}_{CoilNet}$$

is the admittance of the electric network excluding the arc suppression device 10.

It should be noted that in the previous equations Y̅_{oTr} neglected as its impedance value is significantly smaller compared to coil impedance. Therefore, this assumption does not affect the results, and the following analysis are valid.

The following conclusions can be made:
The outcome of the current injection therefore may essentially depend on the following parameters:
   Ī′ᵢₙⱼ, the magnitude of the current injection. The phase angle is meaningful if the frequency of the injected current is equal to fₛ
   ωᵢ, the angular frequency of the current injection.
   I_{d}, the magnitude of the electric network damping. The lower the damping, the greater the outcome of the current injection may be.

$${I}_{v}^{′} = \frac{{ω}_{s}}{{ω}_{i}} {I}_{Ltot} - \frac{{ω}_{i}}{{ω}_{s}} {I}_{Ctot} ,$$

the magnitude of the frequency-scaled electric network detuning. More specifically, the result of the injection may depend on the difference between the electric network capacitive current to the inductive current when scaled considering the ratio of the current injection frequency fᵢ to fₛ. The closer the frequency-scaled detuning is to zero, the higher the outcome of the current injection may be.
At the electric network resonant frequency, the zero-sequence voltage response is highest, so that the zero-sequence impedance, representing the load of the current injection, is limited to the resistive losses in the zero-sequence system, in other words, the electric network damping.
   Power requirement of the current injection is minimal at the resonant frequency of the system.
The zero-sequence impedance is the highest (admittance is the lowest) at the resonant frequency.
   For example, minimum current injection amplitude is needed to achieve a certain voltage response.

For current injections with frequency equal to fₛ the following equation further describes the voltage response due to current injection considering the asymmetry of the electric network:

$${U}_{0} = \frac{- {\overline{I}}_{asymm} + {\overline{I}}_{inj}}{{I}_{d} - {jI}_{v}} {U}_{PE}$$

where:
Iᵥ=I_{Ltot}−I_{Ctot} is the electric network detuning at fₛ
Ī_{asymm} is the asymmetric current due to asymmetry of the phase wise admittances presented with asymmetry admittance Y̅_{asymm}.

The asymmetric current Ī_{asymm} due to natural asymmetry may be expressed as follows:

$${\overline{U}}_{0} = - {U}_{P E} \frac{{\overline{Y}}_{a s y m m}}{{\overline{Y}}_{a s y m m} + {\overline{Y}}_{s y m m} + {\overline{Y}}_{C o i l}}$$

$${\overline{U}}_{0} {\overline{Y}}_{C o i l} = {\overline{I}}_{a s y m m} + {\overline{U}}_{0} {\overline{Y}}_{s y m m} ⇒ {\overline{I}}_{a s y m m} = {\overline{U}}_{0} ( {\overline{Y}}_{C o i l} - {\overline{Y}}_{s y m m} )$$

$${\overline{I}}_{a s y m m} = - {U}_{P E} \frac{( {\overline{Y}}_{c o i l} + {\overline{Y}}_{s y m m} ) {\overline{Y}}_{a s y m m}}{{\overline{Y}}_{a s y m m} + {\overline{Y}}_{s y m m} + {\overline{Y}}_{c o i l}}$$

The following conclusions can be made:
The outcome of the current injection with frequency equal to fₛ therefore may essentially also depend on the following parameters:
   Ī_{asymm}, the magnitude of the asymmetric current due to asymmetry of the phase wise admittances. The higher the asymmetry, the higher the Ī_{asymm}.
   Phase angle difference between Īᵢₙⱼ and Ī_{asymm}. The angle difference, for example, determines whether the natural zero-sequence voltage is increased or decreased by the current injection.

The resonant frequency of the zero-sequence system can further be understood when analyzing the following equation describing the resonant frequency:

$${f}_{r e s} = \frac{1}{2 π \sqrt{\frac{{L}_{C o i l} \cdot {L}_{Net}}{{L}_{C o i l} + {L}_{Net}} {C}_{Net}}} = \frac{1}{2 π \sqrt{{L}_{Tot} {C}_{Tot}}} = {f}_{s} \sqrt{\frac{{I}_{Ltot}}{{I}_{Ctot}}}$$

The following conclusions can be made:
The resonant frequency is essentially directly dependent on the ratio of the inductive to capacitive earth fault current at fₛ.
The resonant frequency varies based on the electric network detuning, and is typically in range of about 10-250 Hz
   To adapt for different resonant frequencies, the current injection frequency should be dynamically selected in some embodiments.
   No single multi-frequency signal or pulse pattern can cover the range 10-250 Hz without significant gaps.

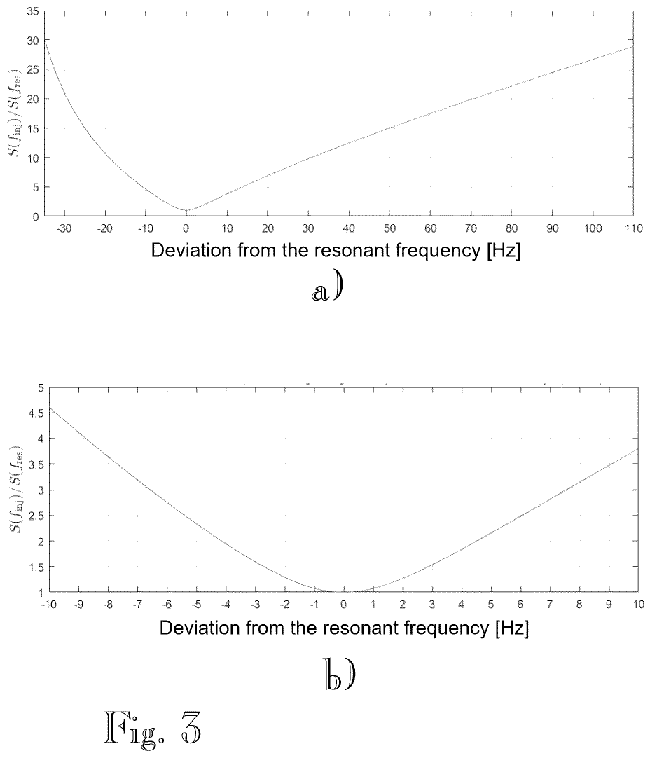

FIG. 3 illustrates an example of a typical output power requirement at various current injection frequencies fin compared to resonant frequency fᵣₑₛ to achieve any voltage response. The power ratio=S(fᵢₙⱼ)/S(fᵣₑₛ) is shown as a function of frequency deviation from the resonant frequency fᵢₙⱼ−fᵣₑₛ. Alternative a) shows a larger frequency range while alternative b) shows in more detail frequency deviation range from −10 to 10 Hz. While the exemplary graph of FIG. 3 illustrates a generalization, it however applies to several configurations, even for different detuning values, and thus generally illustrates the effect of the frequency of the injected current on the required power to obtain corresponding response. For example, when the frequency difference from the resonant frequency is 5 Hz, the power requirement is more than doubled compared to using the resonant frequency. Similarly, a 10 Hz deviation results in approximately four times higher power requirement. This clearly illustrates the benefits of using the resonant frequency compared to other frequencies for networks of different sizes. It should be noted that the results may slightly vary depending on, for example, the selected resonant frequency, however using fᵣₑₛ=50 Hz (in this example the electric network synchronous frequency) can represent average results with sufficient accuracy.

According to an embodiment, a method for controlling an arc suppression device of a three-phase electric network is provided, wherein the arc suppression device has an adjustable admittance connected between a neutral point of the three-phase electric network and earth, comprises determining a resonant frequency of a zero-sequence system of the three-phase electric network, and determining at least two frequencies for a current injection on the basis of the determined resonant frequency. The method further comprises performing a current injection into the neutral point of the three-phase electric network by using the determined at least two frequencies, determining a value of at least one parameter related to the three-phase electric network on the basis of the current injection, and using the determined value of the at least one parameter for adjusting the admittance of the arc suppression device. The using of the determined value of the at least one parameter for adjusting the admittance of the arc suppression device may comprise adjusting the admittance of the arc suppression device on the basis of the determined value of the at least one parameter.

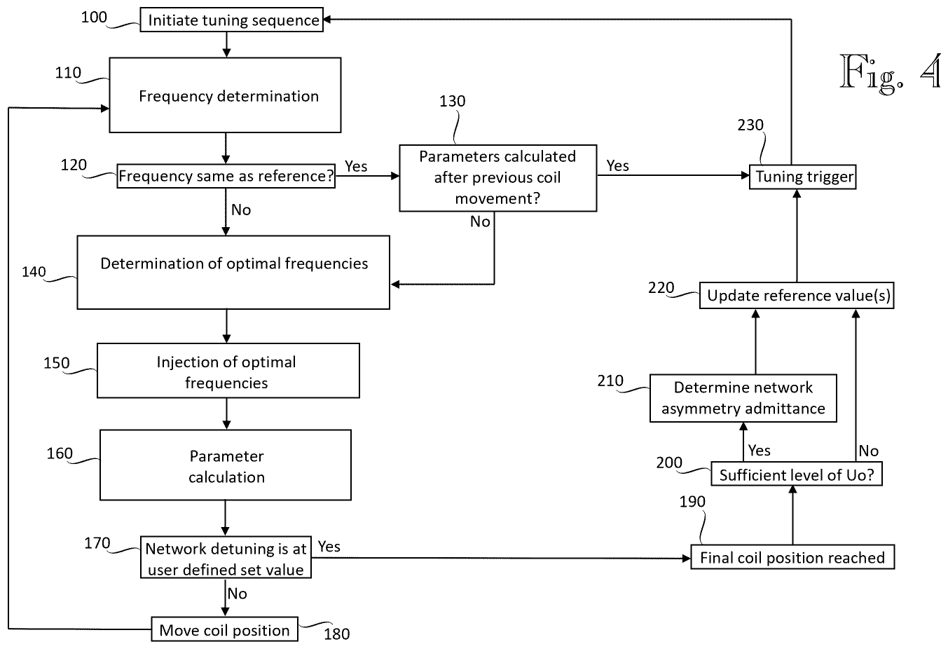

FIG. 4 shows a flow diagram according to an embodiment. It should be noted that the example of FIG. 4 shows several features in some embodiments. The tuning of the arc suppression device 10 is started (initiated) in activity 100. The starting may take place, for example, manually or automatically in response to a predetermined condition being met.

According to an embodiment, the determining of the resonant frequency of the zero-sequence system of the three-phase electric network may comprise sequentially injecting current signals of varying frequency or frequencies into the neutral point of the three-phase electric network, monitoring a response in the three-phase electric network to the sequential injection of the current signals and determining the resonant frequency of the zero-sequence system of the three-phase electric network on the basis of the monitored response in the three-phase electric network to the sequential injection of the current signals. According to an embodiment, the sequential injection of the current signals is performed as a frequency sweep, wherein the frequency or frequencies of the sequentially injected current signals are varied between a predetermined minimum frequency fₘᵢₙ and a predetermined maximum frequency fₘₐₓ. According to an embodiment, the frequency or frequencies of the sequentially injected current signals may be varied between the predetermined minimum frequency and the predetermined maximum frequency in an increasing manner starting from the predetermined minimum frequency or in a decreasing manner starting from the predetermined maximum frequency. According to an embodiment, the frequency or frequencies of the sequentially injected current signals are varied in a continuous manner or in a discrete manner. Accordingly, in activity 110, determining the resonant frequency of the zero-sequence system of the three-phase electric network may include performing the determination of the zero-sequence system resonant frequency with a sufficient accuracy, and in some embodiments, precision that is from fractions of a hertz to a few hertz. According to an embodiment, to accurately determine the resonant frequency, a frequency sweep method may be used, wherein, for example, a sinusoidal current signal is injected with a varying frequency continuously or discretely from fₘᵢₙ to fₘₐₓ, and in some embodiments, with a predetermined frequency step fₛₜₑₚ and time per frequency tₛₜₑₚ, for example, from a few hundred of milliseconds to seconds. According to an embodiment, the injection sequence used for determining the resonant frequency can further be optimized with multiple, in other words, two or more, frequency sweeps with different settings: fₘᵢₙ, fₘₐₓ, fₛₜₑₚ and tₛₜₑₚ and each iteration sweep can be adjusted based on the results of the previous sweep so that the method converges and locates the resonant frequency accurately with the least amount time and least number of injected frequencies. The current injection signal may have the following sinusoidal form:

$${I}_{i n j}^{′} ( t , {f}_{i} , θ ) = {\hat{l}}_{i n j}^{′} sin ( 2 π {f}_{i} t + θ ) , {f}_{i} ∈ [ {f}_{min} , {f}_{max} ] , θ ∈ [ 0 , 2 π ]$$

where:

$${\hat{l}}_{i n j}^{′}$$

is the peak amplitude value of the current singal reduced to primary voltage level, for example,

$${\hat{I}}_{i n j}^{′} = \sqrt{2} \vert {\overline{I}}_{i n j}^{′} \vert$$

t is the time in seconds.

According to an embodiment, the amplitude of the signal

$$\vert {\overline{I}}_{i n j}^{′} \vert$$

(in phasor domain/rms value) in primary voltage level can be selected, for example, by considering the zero-sequence voltage response target Ū_{0_target}, when the electric network damping I_{d} is known or can be estimated:

$$\vert {\overline{I}}_{i n j}^{′} \vert = \frac{\vert {\overline{U}}_{0 \_ target} \vert}{{U}_{P E}} {I}_{d}$$

where: |Ū_{0_target}| is the highest possible voltage response for current injection with amplitude

$$\vert {\overline{I}}_{i n j}^{′} \vert .$$

Also, the maximum allowed injection current level can be calculated using the previous equation.

According to an embodiment, the resonant frequency can then be determined on the basis of the monitored response in the three-phase electric network to the sequential injection of the current signals. According to an embodiment, the resonant frequency can be determined to be the frequency for which the highest or maximum, or generally most significant, response of electrical system is achieved or observed. For example, the frequency at which the electric network zero sequence impedance/admittance is in resonance. Such a highest or maximum, or generally most significant, response of the electrical system may be detected, for example, in response to a predetermined parameter or quantity of the three-phase electric network reaching its highest (maximum) or lowest (minimum) value. This may be determined, for example, according to any one of the following conditions or any combination thereof:
1. Highest effective zero-sequence voltage value: max|Ū₀(fᵢ)| (constant injection current amplitude |Īᵢₙⱼ (fᵢ)| supplied at all frequencies [fₘᵢₙ>fₘₐₓ]),
2. Lowest effective injection device current value: min |Īᵢₙⱼ(fᵢ)| (constant injection voltage amplitude |Ūᵢₙⱼ(fᵢ)| supplied at all frequencies [fₘᵢₙ>fₘₐₓ])
3. Highest effective zero-sequence impedance value: max|Z̅₀(fᵢ)|
4. Lowest effective zero-sequence admittance value: min|Y̅₀(fᵢ)|

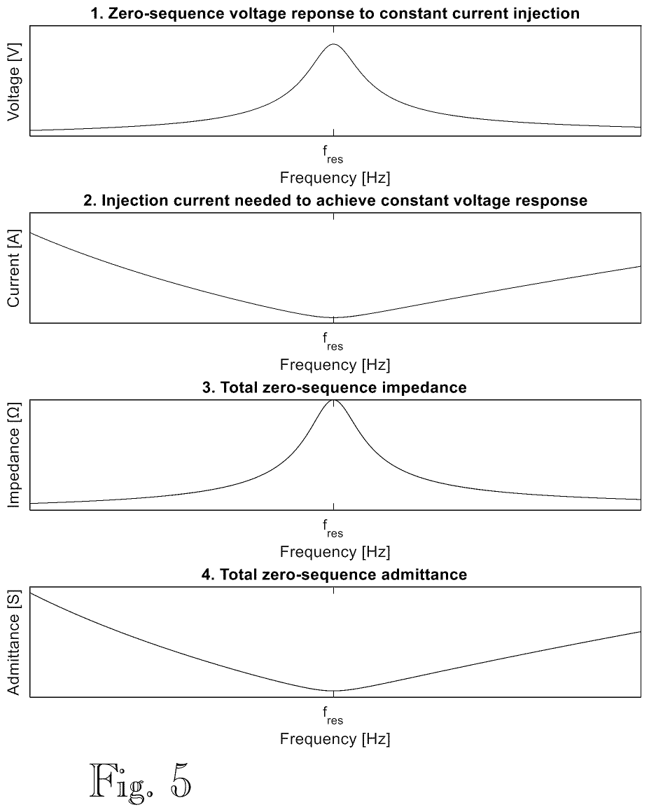

FIG. 5 shows an exemplary diagram in which an example of each of the above situations 1-4 is shown. More specifically, in FIG. 5 the first diagram shows an example of a zero-sequence voltage response curve to a constant current injection, the second diagram shows an example of an injection current needed to achieve a constant voltage response, the third diagram shows an example of a total zero-sequence impedance response curve, and the fourth diagram shows an example of a total zero-sequence admittance response curve. The resonant frequency can then be found on the basis of the maximum or minimum value of the response curve, which represents the highest response to the current injection.

According to an embodiment, the determination of the resonant frequency, for example, for previous conditions 3 and 4, can be expressed by a mathematical formula as follows:

$${f}_{res} = {arg max}_{{f}_{i} ∈ [ {f}_{min} , {f}_{max} ]} \vert {\overline{Z}}_{0} ( {f}_{i} ) \vert$$

$${f}_{res} = {arg min}_{{f}_{i} ∈ [ {f}_{min} , {f}_{max} ]} \vert {\overline{Y}}_{0} ( {f}_{i} ) \vert$$

And, in terms of ωᵢ=2πfᵢ, where fᵢ∈[fₘᵢₙ,fₘₐₓ],

$${ω}_{res} = {arg max}_{{ω}_{i} ∈ [ {ω}_{min} , {ω}_{max} ]} \vert {\overline{Z}}_{0} ( {ω}_{i} ) \vert$$

$${ω}_{res} = {arg min}_{{ω}_{i} ∈ [ {ω}_{min} , {ω}_{max} ]} \vert {\overline{Y}}_{0} ( {ω}_{i} ) \vert$$

According to an embodiment, Z̅₀(fᵢ) and/or Y̅₀(fᵢ) can be determined based on a measured zero-sequence voltage in respect to injection current at the frequency of the current injection when fᵢ≠fₛ (in completely symmetrical networks fᵢ=fₛ is also allowed):

$${\overline{Z}}_{0} ( {f}_{i} ) = \frac{{\overline{U}}_{0} ( {f}_{i} )}{{\overline{I}}_{inj}^{′} ( {f}_{i} )}$$

$${\overline{Y}}_{0} ( {f}_{i} ) = \frac{{\overline{I}}_{inj}^{′} ( {f}_{i} )}{{\overline{U}}_{0} ( {f}_{i} )}$$

According to an embodiment, for fᵢ=fₛ, to determine Z̅₀(fₛ) and Y̅₀(fₛ) the delta calculation can be applied as follows to remove the influence of the natural asymmetry of the electric network:

$${\overline{Z}}_{0} ( {f}_{s} ) = \frac{Δ {\overline{U}}_{0} ( {f}_{s} )}{Δ {\overline{I}}_{inj}^{′} ( {f}_{s} )} = \frac{{\overline{U}}_{0}^{2} ( {f}_{s} ) - {\overline{U}}_{0}^{1} ( {f}_{s} )}{{\overline{I}}_{inj}^{′2} ( {f}_{s} ) - {\overline{I}}_{inj}^{′1} ( {f}_{s} )}$$

$${\overline{Y}}_{0} ( {f}_{s} ) = \frac{Δ {\overline{I}}_{inj}^{′} ( {f}_{s} )}{Δ {\overline{U}}_{0} ( {f}_{s} )} = \frac{{\overline{I}}_{inj}^{′2} ( {f}_{s} ) - {\overline{I}}_{inj}^{′1} ( {f}_{s} )}{{\overline{U}}_{0}^{2} ( {f}_{s} ) - {\overline{U}}_{0}^{1} ( {f}_{s} )}$$

where:

$${\overline{U}}_{0}^{1} ( {f}_{s} ) and {\overline{U}}_{0}^{2} ( {f}_{s} )$$

are responses for two different current injection signals

$${\overline{I}}_{inj}^{′1} ( {f}_{s} ) and {\overline{I}}_{inj}^{′2} ( {f}_{s} ) for which {\overline{I}}_{inj}^{′1} ( {f}_{s} ) \neq {\overline{I}}_{inj}^{′2} ( {f}_{s} )$$

either by amplitude and/or phase angle.

This may require using two different, for example, sequential current injection cycles at the synchronous frequency of the three-phase electric network, fₛ, with different amplitude and/or phase angles.

However, using fᵢ=fₛ or frequencies close to it can also be avoided, so that the frequency range may be modified as follows:

$${f}_{i} ∈ [ {f}_{min} , {f}_{max} ] \backslash {f}_{s} or$$

$${f}_{i} ∈ [ {f}_{min} , {f}_{max} ] \text{\textbackslash [} {f}_{s \_ min} , {f}_{s \_ max} ]$$

where:
   [fₘᵢₙ,fₘₐₓ] is a total frequency range
   [f_{s_min},f_{s_max}] is an excluded frequency range (close to fₛ) so that:
      fₘᵢₙ<f_{s_min}<fₛ
      fₛ<f_{s_max}<fₘₐₓ

According to an embodiment, the injection current may be measured directly at the output of the current injection source, for example, from a power auxiliary winding of the arc suppression device where the current signal may be injected. The zero-sequence voltage response however can be measured from various points, thus resulting alternative variants of the zero-sequence impedance and/or admittance. These variants may include a voltage measurement winding of the arc suppression device, power auxiliary windings of the arc suppression device, open delta windings of a voltage transformer(s) or calculated vector sum of the measured phase voltages, for example, each with different advantages.

According to another embodiment, determining the resonant frequency of the zero-sequence system of the three-phase electric network in activity 110 could be performed as described in EP 1693679 B1, wherein the frequency spectrum is injected not sequentially but simultaneously. The auxiliary injection signal may be injected in a form of a pulse, wherein the frequency spectrum of the injection pulse may cover a range between a selectable minimum and maximum frequencies substantially without gaps and the resonant frequency of the electric system is contained in the frequency spectrum.

According to an embodiment, the sequentially injected current signals may be multifrequency current signals, each comprising at least two different frequencies. Accordingly, in activity 110, determining the resonant frequency of the zero-sequence system of the three-phase electric network could be implemented as a hybrid method wherein a set of different multifrequency current signals (each with, for example, 2 or more frequency components), or pulse patterns are sequentially injected, so that the sequential and simultaneous injection methods may be combined. In this case, by sequentially injecting selected multifrequency signals or pulse patterns, the resonant frequency can be determined efficiently, with a smaller number of required current injection cycles. These multi-frequency signals may have the following form:

$${I}_{inj}^{′} ( t , {f}_{1} , {f}_{2} , ... , {f}_{n} , {θ}_{1} , {θ}_{2} , ... , {θ}_{n} ) = {\hat{I}}_{inj}^{′} ( {f}_{1} ) sin ( 2 π {f}_{1} t + {θ}_{1} ) + {\hat{I}}_{inj}^{′} ( {f}_{2} ) sin ( 2 π {f}_{2} t + {θ}_{2} ) ... + {\hat{I}}_{inj}^{′} ( {f}_{n} ) sin ( 2 π {f}_{n} t + {θ}_{n} )$$

with n≥2 number of frequency components. However, adding more frequency components may also increase the power requirement needed to produce such a multifrequency current injection signal.

After determining the resonant frequency in activity 110, in some embodiments, it may be checked in activity 120 whether the determined frequency corresponds to a reference frequency and, if yes, it may be additionally checked in activity 130, whether any parameters have been calculated after a possible previous coil movement. If yes, the further activities 140-220 may be skipped. Activity 130 can ensure that any calculated parameter value(s) possibly used for further calculations or reference purposes, for example, are re-calculated after every coil movement during the algorithm. According to an embodiment, the reference frequency may correspond to the determined network resonant frequency after a successful coil tuning operation.

According to an embodiment, determining the at least two frequencies, in activity 140, for the current injection on the basis of the determined resonant frequency may comprise selecting a first frequency f₁ and at least one second frequency f₂. Generally, the selection of the two or more frequency components may be based on a mathematical formula and/or any other common principle or criteria that utilizes or is dependent on the found resonant frequency, for example, f₁=fᵣₑₛ and f₂=fᵣₑₛ+1 Hz. According to an embodiment, the determining of the at least two frequencies for the current injection on the basis of the determined resonant frequency comprises selecting a first frequency f₁ and at least one second frequency f₂ according to any one of the following alternatives:

$${f}_{1} = {f}_{res} , {f}_{2} = {f}_{res} + x$$

$${f}_{1} = {f}_{res} + y , {f}_{2} = {f}_{res} + z$$

$${f}_{1} = {f}_{res} \cdot a , {f}_{2} = {f}_{res} \cdot b$$

where:
fᵣₑₛ is the determined resonant frequency,
x, y and z are predetermined and/or dynamically selected variables (value may be positive or negative),
and
a and b are predetermined and/or dynamically selected coefficients (positive value)

The dynamic selection of variables x, y, z and/or coefficients a, b may in this case mean that their value is chosen dynamically based on, for example, the determined resonant frequency fᵣₑₛ. This is because it can be beneficial to adjust the frequency selection depending on the found resonant frequency fᵣₑₛ, for example. Also, the selection of variables x, z and/or coefficient b for selecting f₂ may be dependent on the selection of f₁. Similarly, the selection of variable y and/or coefficient a for selecting f₁ may be dependent on the selection of f₂.

According to an embodiment, determining the at least two frequencies, in activity 140, for the current injection can also utilize the results from a previous frequency sweep in activity 110 so that two or more frequency components are selected directly based on the results of the frequency sweep. In other words, two or more frequencies may be selected directly based on the results/responses given by the frequency sweep. For example, two or more frequencies giving the highest response during the frequency sweep may be selected. There may also be a certain required or predetermined and/or dynamically selected frequency difference between the selected frequencies.

According to an embodiment, other possible/example selections for the at least two frequencies f₁ and f₂ may include any one of the following examples:
Two frequencies giving the highest response during the sweep.
Two frequencies giving the highest response during the sweep so that there is a set frequency difference or ratio between f₁ and f₂.

According to an embodiment, to optimally select the frequencies, at least two conditions should be considered in some embodiments:
A. The electric network's response is highest for frequencies close to the resonant frequency of the electric network, yielding maximum measurement accuracy for the resulting zero-sequence voltage and injected current. Also, the output power requirement for obtaining the highest response becomes minimal.
B. When performing calculation, the numerical stability (immunity to measurement inaccuracies) may be improved when the frequency difference between the selected frequencies is higher.

According to an embodiment, essentially similar frequency selection methods, equations, principles and/or criteria as described in the examples above for selecting the two frequencies f₁ and f₂ can be applied in an essentially similar manner also for selecting any number of frequencies more than two, for example, f₁, f₂, . . . , fₙ, where n is the number of selected frequencies (greater than two). Generally, the number n (≥2) of such frequencies fₙ may be selected case-specifically based on system characteristics.

According to an embodiment, determining the at least two frequencies, in activity 140, for the current injection can further be adjusted so that fₛ (the electric network frequency) or any frequency that is close to fₛ may be disregarded. In such a case the next best possible frequency option may be selected. For example, this could be implemented to avoid the need to inject current at the electric network's frequency and/or to consider the digital filter implementations that may be required to remove the influence of the electric network frequency component from the measurements.

After determining the at least two frequencies in activity 140 for the current injection, a current injection into the neutral point of the three-phase electric network may then be performed in activity 150 by using the determined at least two frequencies.

According to an embodiment, the injection current amplitude in activity 150 can be adjusted to the suitable level based on the analyzed network response during activity 110. According to an embodiment, this can be done, for example, as follows:
1. An estimate value of the total electric network damping can be calculated based on an achieved network voltage response at the resonant frequency during activity 110:

$${I}_{d} = \frac{{U}_{PE}}{\vert {\overline{U}}_{0} ( {f}_{res} ) \vert} \vert {\overline{I}}_{inj}^{′} ( {f}_{res} ) \vert$$

where: |Ū₀(fᵣₑₛ)| is the measured voltage response for the measured current injection amplitude

$$\vert {\overline{I}}_{inj}^{′} ( {f}_{res} ) \vert$$

during activity 110 at fᵣₑₛ
2. A suitable current injection amplitude can then be calculated using the estimated value of the electric network damping:

$$\vert {\overline{I}}_{inj}^{′} \vert = \frac{\vert {\overline{U}}_{0 \_ target} \vert}{{U}_{PE}} {I}_{d}$$

where: |Ū_{0_target}| is the target voltage response (sufficient zero-sequence voltage response that does not exceed earth-fault detection threshold) for current injection with amplitude

$$\vert {\overline{I}}_{inj}^{′} \vert .$$

In some embodiments, it may be further beneficial to select higher amplitudes for the current injections with at least two frequencies

$$\vert {\overline{I}}_{inj}^{′} ( {f}_{1} ) \vert and \vert {\overline{I}}_{inj}^{′} ( {f}_{2} ) \vert$$

depending on the values between f₁ and f₂ compared to fᵣₑₛ. This can be done dynamically by considering the difference between f₁ and f₂ compared to fᵣₑₛ. For instance, the higher the difference, the higher amplitude for current is selected. This can be based on a mathematical formula or equation or any set criteria that, for example, consider values f₁, f₂ and fᵣₑₛ and their difference. Also, the information shown in the examples of FIG. 3, or corresponding information, can be used when selecting the current injection amplitude for the at least two frequencies f₁ and f₂ that may have a certain deviation from the resonant frequency fᵣₑₛ. The power ratio=S(fᵢₙⱼ)/S(fᵣₑₛ) can be, for example, used as a coefficient when selecting the current injection amplitude for the at least two frequencies

$$\vert {\overline{I}}_{inj}^{′} ( {f}_{1} ) \vert and \vert {\overline{I}}_{inj}^{′} ( {f}_{2} ) \vert$$

when considering the frequency deviation between f₁ and f₂ compared to fᵣₑₛ. For this, it may be further beneficial to use multiple versions of power ratio=S(fᵢₙⱼ)/S(fᵣₑₛ) that could be applied for various resonant frequency operation points fᵣₑₛ (exemplary FIG. 3 illustrates average results with fᵣₑₛ=50 Hz). This makes it possible to accurately select the amplitudes for current injection with the at least two frequencies

$$\vert {\overline{I}}_{inj}^{′} ( {f}_{1} ) \vert and \vert {\overline{I}}_{inj}^{′} ( {f}_{2} ) \vert$$

based on calculated current injection amplitude

$$\vert {\overline{I}}_{inj}^{′} \vert$$

that applies for current injections with resonant frequency fᵣₑₛ. This can be mathematically expressed as follows:

$$\vert {\overline{I}}_{inj}^{′} ( {f}_{1} ) \vert = PowerRatio \cdot \vert {\overline{I}}_{inj}^{′} \vert$$

$$\vert {\overline{I}}_{inj}^{′} ( {f}_{2} ) \vert = PowerRatio \cdot \vert {\overline{I}}_{inj}^{′} \vert$$

Where:

$$\vert {\overline{I}}_{inj}^{′} ( {f}_{1} ) \vert$$

is the current injection amplitude for frequency f₁ that approximately corresponds to the voltage response target |Ū_{0_target}|

$$\vert {\overline{I}}_{inj}^{′} ( {f}_{2} ) \vert$$

is the current injection amplitude for frequency f₂ that approximately corresponds to the voltage response target |Ū_{0_target}|

$$\vert {\overline{I}}_{inj}^{′} \vert$$

is the calculated current injection amplitude with frequency fᵣₑₛ that corresponds to the voltage response target |Ū_{0_target}|.

PowerRatio is the power ratio (from exemplary FIG. 3 or any other equivalent graph) that corresponds to the frequency deviation between current injection frequency fᵢₙⱼ and fᵣₑₛ.

After or during the current injection in activity 150, a value of at least one parameter related to the three-phase electric network is determined in activity 160 on the basis of the current injection in activity 150. According to an embodiment, the at least one parameter related to the three-phase electric network may comprise one or more of the following parameters: a total zero-sequence resistance of the three-phase electric network, a total zero-sequence inductance of the three-phase electric network, a total zero-sequence capacitance of the three-phase electric network, or any of the previous expressed in terms of currents, for example. Generally, any known applicable equations may be utilized for determining the value of at least one parameter related to the three-phase electric network in activity 160.

According to an embodiment, the solution disclosed in DE 10307668 B3 could be utilized in activity 160 as follows:

$${\overline{Y}}_{0} ( {ω}_{i} ) = \frac{{\overline{I}}_{inj}^{′} ( {ω}_{i} )}{{\overline{U}}_{0} ( {ω}_{i} )} = {G}_{0 Tot} + j ( {ω}_{i} {C}_{Tot} - \frac{1}{{ω}_{i} {L}_{Tot}} )$$

$${{ω}_{1} , {ω}_{2}}_{⇒} \{ \begin{matrix}{C}_{Tot} & = \frac{imag \{ {\overline{Y}}_{0 \_ω 1} \} {ω}_{1} - imag \{ {\overline{Y}}_{0 \_ω 2} \} {ω}_{2}}{{ω}_{1}^{2} - {ω}_{2}^{2}} \\ {L}_{Tot} & = \frac{{ω}_{1}^{2} - {ω}_{2}^{2}}{imag \{ {\overline{Y}}_{0 \_ω 1} \} {ω}_{1} {ω}_{2}^{2} - imag \{ {\overline{Y}}_{0 \_ω 2} \} {ω}_{2} {ω}_{1}^{2}}\end{matrix}$$

$${I}_{v} = {U}_{PE} ( \frac{1}{{ω}_{s} {L}_{Tot}} - {ω}_{i} {C}_{Tot} )$$

Or according to an alternative embodiment:

$${\overline{Y}}_{0} ( {ω}_{i} ) = \frac{{\overline{I}}_{inj}^{′} ( {ω}_{i} )}{{\overline{U}}_{0} ( {ω}_{i} )} = \frac{1}{{U}_{PE}} \cdot ( {I}_{d} - j ( \frac{{ω}_{s}}{{ω}_{i}} {I}_{Ltot} - \frac{{ω}_{i}}{{ω}_{s}} {I}_{Ctot} ) )$$

$${{ω}_{1} , {ω}_{2}}_{⇒} \{ \begin{matrix}{I}_{Ctot} & = {U}_{PE} {ω}_{s} \frac{imag \{ {\overline{Y}}_{0 \_ω 1} \} {ω}_{1} - imag \{ {\overline{Y}}_{0 \_ω 2} \} {ω}_{2}}{{ω}_{1}^{2} - {ω}_{2}^{2}} \\ {I}_{Ltot} & = {U}_{PE} \frac{{ω}_{1} {ω}_{2}}{{ω}_{s}} \frac{imag \{ {\overline{Y}}_{0 \_ω 1} \} {ω}_{2} - imag \{ {\overline{Y}}_{0 \_ω 1} \} {ω}_{2}}{{ω}_{1}^{2} - {ω}_{2}^{2}} \\ {I}_{d} & = real \{ {\overline{Y}}_{0 \_ω 1} \} {U}_{PE}\end{matrix}$$

According to an embodiment, the electric network detuning at fₛ can then be calculated as follows: Iᵥ=I_{Ltot}−I_{Ctot}

After determining the value of at least one parameter in activity 160, the determined value of the at least one parameter is used for adjusting the admittance of the arc suppression device 10. The use of the determined value of the at least one parameter for adjusting the admittance of the arc suppression device may comprise adjusting the admittance of the arc suppression device on the basis of the determined value of the at least one parameter. In some embodiments, such use may comprise first checking activity 170, based on the determined value of the at least one parameter, whether the electric network detuning is at a predetermined or desired, for example, a user defined, value or level. If not, the admittance of the arc suppression device 10 may then be adjusted, which may comprise, for example, suitably moving the coil position in activity 180, on the basis of the determined value of the at least one parameter. The adjusting of the admittance of the arc suppression device 10 on the basis of the determined value of the at least one parameter may be generally performed by any suitable manner known as such, for example, and the implementation may depend on the characteristics of the arc suppression device 10. After such adjustment, it is possible to proceed back to activity 110 in order to redetermine the value of the at least one parameter. Thus, the adjusting of the admittance of the arc suppression device 10 may comprise consecutive rounds of adjustments until the electric network detuning is at a predetermined or desired value or level, for example, a user-defined value. According to another embodiment, it would be possible to proceed from activity 180 directly to activity 190, for example.

According to an embodiment, after the arc suppression device 10 has reached the final adjusted position in activity 190, it may be checked in activity 200 whether the resulting value of the zero-sequence voltage is of a sufficient level (magnitude).

According to an embodiment, it is possible to further determine in activity 210 a network asymmetry admittance. In some embodiments, activity involves additional calculations needed to solve the resonance curve, which however is not required in the coil tuning application but may be calculated for illustrative purposes, for example. In activity 210, the solution obtained in activity 160 may be extended so that the asymmetrical and symmetrical part of the zero-sequence impedance, admittance and/or current can be solved. This can be done using any known method, wherein the asymmetrical part of the zero-sequence admittance (or asymmetry in current form) is solved based on the solved network parameter(s) in activity 160, for example. This can be done, for example, using the following equation:

$${U}_{0} = \frac{{I}_{asymm}}{\vert {I}_{d} - j \cdot {I}_{v} \vert} {U}_{PE}$$

where:
   U₀ is the absolute of the zero-sequence voltage (residual voltage),
   I_{asymm} is the absolute value of an asymmetric current that describes the electric network asymmetry (unbalance),
   Iᵥ is the electric network detuning at fₛ (solved in activity 160),
   I_{d} is the total electric network damping including parallel resistor (solved in activity 160), and
   U_{PE} is the rated phase-to-ground voltage.

According to an embodiment, in practice the resonance curve calculation may require the following activities:
1. Determine the total electric network detuning Iᵥ and damping I_{d} (solved in activity 160)
2. Calculate distributed compensation using:

$${I}_{Lnet} = {I}_{Ltot} - {I}_{pos}$$

where:
I_{Ltot} is the total inductive earth fault current produced by the connected arc suppression device and any distributed arc suppression device(s) at fₛ of the electric network (solved in activity 160),
Iₚₒₛ is the position of the adjustable coil in terms of amperes, and
I_{Lnet} is the inductive earth fault current of the electric network due to any distributed arc suppression device(s) at fₛ.
3. Measure absolute value of a healthy state residual voltage U₀
4. Calculate absolute value of the asymmetric current I_{asymm} using equation:

$${I}_{asymm} = \frac{{U}_{0}}{{U}_{PE}} \vert {I}_{d} - j \cdot {I}_{v} \vert$$

5. Calculate residual voltage U₀ as a function of coil position in amperes Iₚₒₛ using equation:

$${U}_{0} ( {I}_{pos} ) [ V ] = \frac{{I}_{asymm}}{\vert {I}_{d} - j \cdot ( {I}_{pos} + {I}_{Lnet} - {I}_{Ctot} ) \vert} {U}_{PE}$$

or with per unit value:

$${U}_{0} ( {I}_{pos} ) [ pu ] = \frac{{I}_{asymm}}{\vert {I}_{d} - j \cdot ( {I}_{pos} + {I}_{Lnet} - {I}_{Ctot} ) \vert}$$

The coil position values (Iₚₒₛ) correspond to the coil tuning range of the adjustable coil in amperes.

An example of a resonance curve is shown in FIG. 6.

According to an embodiment, after activity 210, or directly after activity 200, values of, for example, the frequency references, and/or references for the electric network zero-sequence impedance and/or admittance and/or zero-sequence voltage may be updated.

According to an embodiment, at least activities 110, 120, 140, 150, 160 and 180, and in some embodiments, activity 170, may be repeated essentially continuously or at predetermined intervals or in response to detecting a change in a configuration of the three-phase electric network. As an example, in activity 230, it may be waited for a remaining time of a predetermined tuning interval and/or for a trigger based on the zero-sequence voltage and/or for a trigger based on an active injection response and/or for a trigger based on the detected change in the three-phase electric network zero-sequence system resonant frequency and/or manual trigger before initiating the tuning sequence again in activity 100.

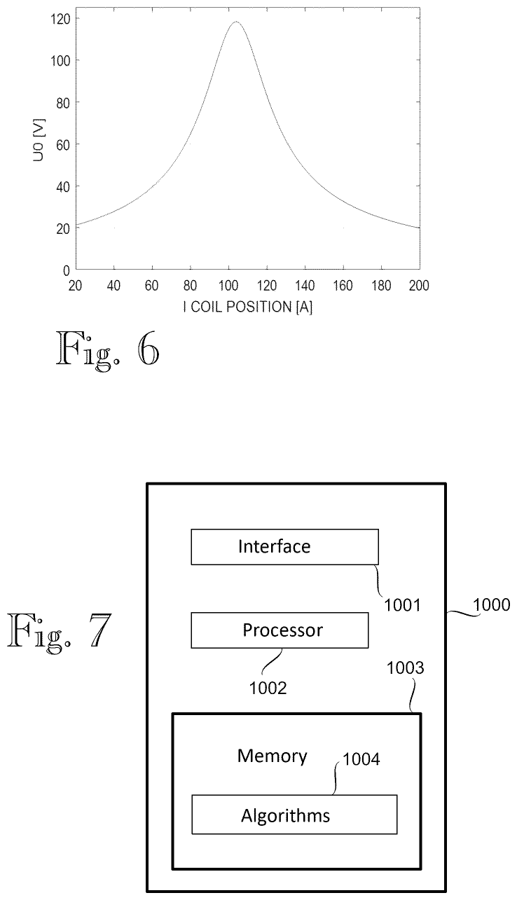

The first control arrangement 11, the second control arrangement 31, or a combination thereof, and/or any other means for implementing at least part of the functionality according to any one of the embodiments herein may be implemented as one physical unit or as two or more separate physical units that are configured to implement the functionality. Herein the term ‘unit’ generally refers to a physical or logical entity, such as a physical device or a part thereof or a software routine. FIG. 7 is a simplified block diagram illustrating some units for an apparatus (device, equipment) 1000 configured to perform at least some functionality of the first control arrangement 11, the second control arrangement 31, or a combination thereof, or generally any corresponding apparatus. In the illustrated example, the apparatus 1000 comprises one or more interface (IF) entities 1001, such as one or more user interfaces and/or data interfaces, and one or more processing entities 1002 connected to various interface entities 1001 and to one or more memories 1003. The one or more interface entities 1001 may be entities for receiving and transmitting information, such as communication interfaces comprising hardware and/or software for realising communication connectivity according to one or more communication protocols, or for realising data, for example, measuring data, storing and fetching, and/or for providing user interaction via one or more user interfaces. A processing entity 1002 is capable to perform calculations and configured to implement at least part of functionalities/operations described above, with corresponding algorithms 1004 stored in the memory 1003. The processing entity 1002 may include one or more processors, controllers, control units, micro-controllers, or similar components configurable to carry out, for example, embodiments, examples, implementations and/or operations described above. Generally, a processor may be a central processing unit, but the processor entity 1002 may be an additional operation processor or a multicore processor or a microprocessor, for instance. A memory 1003 may be usable for storing a computer program code required for one or more functionalities/operations described above, that is, the algorithms 1004 for implementing the functionality/operations described above. The memory 1003 may also be usable for storing, at least temporarily, other possible information required for one or more functionalities/operations described above. The memory 1003 may comprise a data buffer that may, at least temporarily, store measurement data and/or information received as a user input. The apparatus comprising the means for providing any embodiment described herein may be implemented at least partly by means by such apparatus 1000 as exemplified in FIG. 7.

Generally, first control arrangement 11, the second control arrangement 31, or a combination thereof, and/or any other means for implementing at least part of the functionality according to any one of the embodiments herein may be implemented at least partly by means of one or more computers or corresponding digital signal processing (DSP) equipment provided with suitable software. In some embodiments, such a computer or digital signal processing equipment comprises at least a working memory (RAM) providing storage area for arithmetical operations, and a central processing unit (CPU), such as a general-purpose digital signal processor. The CPU may comprise a set of registers, an arithmetic logic unit, and a control unit. The CPU control unit is controlled by a sequence of program instructions transferred to the CPU from the RAM. The CPU control unit may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The computer may also have an operating system which may provide system services to a computer program written with the program instructions. The computer or other apparatus implementing the various embodiments, or a part thereof, may further comprise suitable input means for receiving, for example, measurement and/or control data, and output means for outputting, for example, control or any other data. It is also possible to use a specific integrated circuit or circuits, such as application-specific integrated circuits (ASIC), digital signal processing devices (DSPD), programmable logic devices (PLD), field-programmable gate arrays (FPGA) and/or discrete electric components and devices for implementing the functionality according to any one of the embodiments.

The various embodiments described herein can be implemented at least partly in existing system elements, such as various arc suppression device(s) or similar device(s), and/or by using separate dedicated elements or devices in a centralized or distributed manner. Present arc suppression devices for electric networks may comprise processors and memory that may be utilized in the functions according to the various embodiments described herein. Generally, many electric devices, such as electric power systems, and components thereof, such as intelligent electronic devices, may comprise processors and memory that may also be utilized in implementing the functionality according to the various embodiments described herein. Thus, at least some modifications and configurations possibly required for implementing an embodiment could be performed as software routines, which may be implemented as added or updated software routines. If at least part of the functionality of any of the embodiments is implemented by software, such software may be provided as a computer program product comprising computer program code which, when run on a computer, causes the computer or corresponding arrangement to perform the functionality according to the embodiments as described herein. Such a computer program code may be stored or generally embodied on a computer readable medium, such as suitable memory, for example, a flash memory or an optical memory, from which it is loadable to the unit or units executing the program code. In addition, such a computer program code implementing any of the embodiments may be loaded to the unit or units executing the computer program code via a suitable data network, for example, and it may replace or update a possibly existing program code. An embodiment may provide a computer program embodied on any client-readable distribution/data storage medium or memory unit(s) or article(s) of manufacture, comprising program instructions executable by one or more processors/computers, which when loaded into an apparatus, constitute the control arrangement, or any corresponding unit or an entity providing corresponding functionality, or at least part of the corresponding functionality. Programs, also called program products, including software routines, program snippets constituting “program libraries”, applets and macros, can be stored in any medium and may be downloaded into an apparatus. In other words, each or some or one of the possible units/sub-units and/or algorithms for one or more functions/operations described above, for example by means of any of FIGS. 1 to 7 and any combination thereof, may be an element that comprises one or more arithmetic logic units, a number of special registers and control circuits.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for controlling an arc suppression device of a three-phase electric network, the arc suppression device having an adjustable admittance connected between a neutral point of the three-phase electric network and earth, the method comprising:
a) determining a resonant frequency of a zero-sequence system of the three-phase electric network;
b) determining at least two frequencies for a current injection based on the determined resonant frequency;
c) performing a current injection into the neutral point of the three-phase electric network by using the determined at least two frequencies;
d) determining a value of at least one parameter related to the three-phase electric network based on the current injection; and
e) using the determined value of the at least one parameter for adjusting the admittance of the arc suppression device.

2. The method of claim 1, wherein determining of the resonant frequency of the zero-sequence system of the three-phase electric network further comprises:
sequentially injecting current signals of varying frequency or frequencies into the neutral point of the three-phase electric network;
monitoring a response in the three-phase electric network to the sequential injection of the current signals; and
determining the resonant frequency of the zero-sequence system of the three-phase electric network based on the monitored response in the three-phase electric network to the sequential injection of the current signals.

3. The method of claim 2, wherein the current signals are multifrequency current signals, and wherein each multifrequency current signal comprises at least two different frequencies.

4. The method of claim 2, wherein the sequential injection of the current signals is performed as a frequency sweep, and wherein the frequency or frequencies of the sequentially injected current signals are varied between a predetermined minimum frequency and a predetermined maximum frequency.

5. The method of claim 4, wherein the frequency or frequencies of the sequentially injected current signals are varied between the predetermined minimum frequency and the predetermined maximum frequency in an increasing manner starting from the predetermined minimum frequency or in a decreasing manner starting from the predetermined maximum frequency.

6. The method of claim 5, wherein the frequency or frequencies of the sequentially injected current signals are varied in a continuous manner or in a discrete manner.

7. The method of claim 1, wherein determining the at least two frequencies for the current injection based on the determined resonant frequency comprises:
selecting a first frequency f₁ and at least one second frequency f₂ according to any one of the following alternatives:
$${f}_{1} = {f}_{res} , {f}_{2} = {f}_{res} + x ,$$
$${f}_{1} = {f}_{res} + y , {f}_{2} = {f}_{res} + z , or , or$$
$${f}_{1} = {f}_{res} \cdot a , {f}_{2} = {f}_{res} \cdot b ,$$
where:
fᵣₑₛ is the determined resonant frequency,
x, y and z are predetermined and/or dynamically selected variables, and
a and b are predetermined and/or dynamically selected coefficients.

8. The method of claim 1, wherein the at least one parameter related to the three-phase electric network comprises one or more of the following parameters: a total zero-sequence resistance of the three-phase electric network, a total zero-sequence inductance of the three-phase electric network, and a total zero-sequence capacitance of the three-phase electric network.

9. The method of claim 1, wherein activities a) to e) are repeated continuously or at predetermined intervals or in response to detecting a change in a configuration of the three-phase electric network.

10. An apparatus for controlling an arc suppression device of a three-phase electric network, the arc suppression device having an adjustable admittance connected between a neutral point of the three-phase electric network and earth, the apparatus configured to:
determine a resonant frequency of a zero-sequence system of the three-phase electric network;
determine at least two frequencies for a current injection based on the determined resonant frequency;
perform a current injection into the neutral point of the three-phase electric network using the determined at least two frequencies;
determine a value of at least one parameter related to the three-phase electric network based on the current injection; and
use the determined value of the at least one parameter for adjusting the admittance of the arc suppression device.

11. The apparatus of claim 10, wherein the apparatus is further configured, to determine the resonant frequency of the zero-sequence system of the three-phase electric network, to:
sequentially inject current signals of varying frequency or frequencies into the neutral point of the three-phase electric network;
monitor a response in the three-phase electric network to the sequential injection of the current signals; and
determine the resonant frequency of the zero-sequence system of the three-phase electric network based on the monitored response in the three-phase electric network to the sequential injection of the current signals.

12. The apparatus of claim 11, wherein the current signals are multifrequency current signals, and wherein each multifrequency current signal comprises at least two different frequencies.

13. The apparatus of claim 11, wherein the apparatus is further configured to:
perform the sequential injection of the current signals as a frequency sweep; and
vary the frequency or frequencies of the sequentially injected current signals between a predetermined minimum frequency and a predetermined maximum frequency.

14. The apparatus of claim 13, wherein the apparatus is further configured to vary the frequency or frequencies of the sequentially injected current signals between the predetermined minimum frequency and the predetermined maximum frequency in an increasing manner starting from the predetermined minimum frequency or in a decreasing manner starting from the predetermined maximum frequency.

15. The apparatus of claim 14, wherein the apparatus is further configured to vary the frequency or frequencies of the sequentially injected current signals in a continuous manner or in a discrete manner.

16. The apparatus of claim 10, wherein the apparatus is further configured to determine the at least two frequencies for the current injection based on the determined resonant frequency by selecting a first frequency f₁ and at least one second frequency f₂ according to any one of the following alternatives:
$${f}_{1} = {f}_{res} , {f}_{2} = {f}_{res} + x ,$$
$${f}_{1} = {f}_{res} + y , {f}_{2} = {f}_{res} + z , or$$
$${f}_{1} = {f}_{res} \cdot a , {f}_{2} = {f}_{res} \cdot b ,$$
where:
fᵣₑₛ is the determined resonant frequency,
x, y and z are predetermined and/or dynamically selected variables, and
a and b are predetermined and/or dynamically selected coefficients.

17. The apparatus of claim 10, wherein the at least one parameter related to the three-phase electric network comprises one or more of the following parameters: a total zero-sequence resistance of the three-phase electric network, a total zero-sequence inductance of the three-phase electric network, and a total zero-sequence capacitance of the three-phase electric network.

18. A controller for an arc suppression device for a three-phase electric network, the arc suppression device having an adjustable admittance configured to be connected between a neutral point of the three-phase electric network and earth, the controller comprising a processor and a memory storing instructions that, when executed by the processor, cause the controller to:
determine a resonant frequency of a zero-sequence system of the three-phase electric network;
determine at least two frequencies for a current injection based on the determined resonant frequency;
perform a current injection into the neutral point of the three-phase electric network using the determined at least two frequencies;
determine a value of at least one parameter related to the three-phase electric network based on the current injection; and
adjust the admittance of the arc suppression device using the determined value of the at least one parameter.

19. The controller of claim 18, wherein the instructions that cause the controller to determine the resonant frequency of the zero-sequence system of the three-phase electric network further cause the controller to:
sequentially inject current signals of varying frequency or frequencies into the neutral point of the three-phase electric network;
monitor a response in the three-phase electric network to the sequential injection of the current signals; and
determine the resonant frequency of the zero-sequence system of the three-phase electric network based on the monitored response in the three-phase electric network to the sequential injection of the current signals.

20. The controller of claim 18, wherein the instructions that cause the controller to determine the resonant frequency of the zero-sequence system of the three-phase electric network further cause the controller to:
perform the sequential injection of the current signals as a frequency sweep; and
vary the frequency or frequencies of the sequentially injected current signals-between a predetermined minimum frequency and a predetermined maximum frequency.
